(19) United States
(12) Patent Application Publication
(10) Pub. No.: US 2005/0262548 A1
(43) Pub. Date: Nov. 24, 2005

(54) Terminal device, contents delivery system, information output method and information output program

(75) Inventors: Takashi Shimojo, Kanagawa (JP); Takeshi Nakata, Tokyo (JP)

Correspondence Address: GREENBLUM & BERNSTEIN, P.L.C., 1950 ROLAND CLARKE PLACE, RESTON, VA, 20191, US

(73) Assignee: Dwango Co., Ltd., Tokyo (JP)

(21) Appl. No.: 10/950,440

(22) Filed: Sep. 28, 2004

(30) Foreign Application Priority Data
May 19, 2004 (JP) 2004-149404
Aug. 6, 2004 (JP) 2004-231038

(51) Int. Cl. H04N 5/46; H04N 7/16; H04N 7/173

(52) U.S. Cl. 725/135; 725/100; 725/131

(57) ABSTRACT

The present invention provides a terminal capable of receiving information corresponding to scenes of a television broadcast while the television broadcast is being viewed on a television set. A contents delivery system includes the terminal and an output device for receiving and displaying broadcast data delivered from a broadcasting station. The terminal has an identification information acquisition section for acquiring identification information displayed on the screen of the output device, the identification information being included in the broadcast data and changing with time. A relevant information extractor extracts relevant information, relating to contents to be broadcast according to the broadcast data, from the identification information. An output section outputs the relevant information extracted by the relevant information extraction section.

The present disclosure relates to subject matter contained in Japanese Patent Application No. 2004-231038, filed on Aug. 6, 2004 and Japanese Patent Application No. 2004-149404, filed on May 19, 2004, the disclosures of which are expressly incorporated herein by reference in their entirety.

### BACKGROUND OF THE INVENTION

1. Field of the Invention

The present invention relates to a terminal device, a contents delivery system, an information output method and an information output program, for transmitting information relating to broadcast contents being transmitted to the terminal device.

2. Description of the Prior Art

Conventionally, television broadcasting waves transmitted from a broadcasting station are received by a television receiver (hereafter referred to as a “television set”), and images and sound serving as broadcast contents are output to an output/display screen and a speaker. A viewer can select the channel of a program he/she wants to watch, watch the program and enjoy broadcasting.

Recently, however, a mobile terminal, such as a mobile phone, can be used as a remote control device for a television set. In other words, application software (hereafter referred to as an “application”) for performing the remote control function of the television set is stored in the mobile terminal, or previously downloaded from a server and stored By reading out and executing this application, the remote control function can be performed by using the mobile terminal.

When an attempt is made to provide some sort of information in addition to ordinary broadcast contents for the viewer so that he/she can further enjoy the television broadcast, it is desirable that the above-mentioned mobile terminal should likewise provide the additional information.

A system that uses a mobile terminal for television reception is described in the following prior art, Patent document 1.

Patent Document 1

Japanese Published Unexamined Patent Application No. JP-A-2001-218273

With this system, television broadcast contents themselves can be watched by using a mobile terminal.

However, the technology described in Patent document 1 is for watching a television broadcast using a mobile terminal itself; hence, an ordinary television broadcast is simply watched on the mobile terminal instead of a television set. New information is not added. Furthermore, because a viewer typically desires to watch a television broadcast on a large screen of a television set, or the like, in terms of better viewability and reality, it is preferable to receive and output television broadcasting waves using a television set. Moreover, when a broadcast is viewed on a television set and additional information is delivered to a mobile terminal, among sequentially changing programs, and the scenes and commercials inside the programs, information relating to scenes that may be of interest to a user should be delivered, whereby it is believed that the user can further enjoy the television broadcast he/she is watching.

In view of these circumstances, the invention is intended to provide a terminal device, a contents delivery system, an information output method and an information output program, capable of receiving information corresponding to the scenes of a television broadcast while the television broadcast is being watched on a television set.

### SUMMARY OF THE INVENTION

In view of the above, the present invention through one or more of its various aspects and/or embodiments is presented to accomplish one or more objectives and advantages, such as those noted below.

An aspect of the present invention provides a terminal device that includes an identification information acquirer for acquiring identification information output to a display screen of an output device for receiving and displaying broadcast data from a broadcasting station. The identification information is transmitted in the broadcast data and changes over time. The terminal device further includes a relevant information extracter for extracting relevant information from the identification information, the relevant information relating to contents to be broadcast according to the broadcast data. An output outputs the relevant information.

The identification information may further include reference information for gaining access to a contents delivery device for delivering contents, including more detailed contents relating to broadcast contents. Accordingly, the terminal device further includes a receiver for receiving the more detailed contents from the contents delivery device based on the reference information. The output for outputs the received contents.

Another aspect of the present invention provides a terminal device that includes an identification information acquirer, for acquiring identification information output to a display screen of an output device for receiving and displaying broadcast data from a broadcasting station, and a receiver, for receiving contents from a contents delivery device, based on the identification information. The identification information is included in the broadcast data and changes over time, and the contents includes relevant information relating to broadcast contents to be broadcast according to the broadcast data. An output outputs the received contents.

The relevant information may include information regarding performers and/or information regarding articles included in the broadcast contents. The received contents may include a time when the identification information is output to the display screen and the identification information.

Another aspect of the present invention provides a contents delivery system including a display device for receiving broadcast data delivered from a broadcasting station and for outputting the broadcast data, a contents delivery device for delivering contents, and a terminal. The terminal includes an identification information acquirer for acquiring identification information output to a display screen of the display device, and a receiver for accessing the contents delivery device based on the identification information, and for receiving, from the contents delivery device, relevant information relating to contents to be broadcast according to the broadcast data, and an output for outputting the contents. The identification information being transmitted in the broadcast data and changing overtime. The contents delivery device delivers, to the terminal, the contents corresponding to the identification information transmitted from the terminal. The identification information and the contents may be renewed during broadcasting.

Another aspect of the present invention provides an information output method, which includes acquiring identification information included in receiving broadcast data delivered from a broadcasting station and output to a screen of an output device, and extracting relevant information from the acquired identification information. The identification information changes over time, and the relevant information relates to contents to be broadcast according to the broadcast data. The extracted relevant information is output.

Another aspect of the present invention provides an information output method, which includes acquiring identification information output to a display screen of an output device that receives and displays broadcast data from a broadcasting station. The identification information being included in the broadcast data and changing over time. The method further includes accessing a contents delivery device based on the acquired identification information, and receiving, from the said contents delivery device, contents including relevant information relating to contents to be broadcast according to the broadcast data. The received contents are output.

Yet another aspect of the present invention provides a computer readable medium for storing a computer program that outputs identification information. The computer readable medium includes an acquiring code segment, an extracting code segment and an outputting code segment. The acquiring code segment acquires identification information output to a display screen of an output device that receives and displays broadcast data delivered from a broadcasting station identification information being included in the broadcast data and changing with time. The extracting code segment extracts relevant from the acquired identification information, the relevant information relating to contents to be broadcast according to said broadcast data. The outputting code segment outputs the extracted relevant information.

Another aspect of the present invention provides a computer readable medium for storing a computer program that outputs identification information. The computer readable medium includes an acquiring code segment, an accessing code segment and an outputting code segment. The acquiring code segment acquires identification information output to a display screen of an output device that receives and displays broadcast data from a broadcasting station, the identification information being included in the broadcast data and changing with time. The accessing code segment accesses contents delivery device based on the acquired identification information and receiving, from the contents delivery device, relevant information relating to contents to be broadcast according to the broadcast data. The outputting code segment outputs the relevant information.

### BRIEF DESCRIPTION OF THE DRAWINGS

FIG. 1 is a schematic block diagram showing the configuration of the contents delivery system in accordance with an embodiment of the invention;

FIG. 2 is a list showing exemplary information to be stored in the contents storage section 31, and

FIG. 3 is a sequence diagram for illustrating the operation of the contents delivery system in accordance with an embodiment of the invention.

### DETAILED DESCRIPTION OF THE PREFERRED EMBODIMENTS

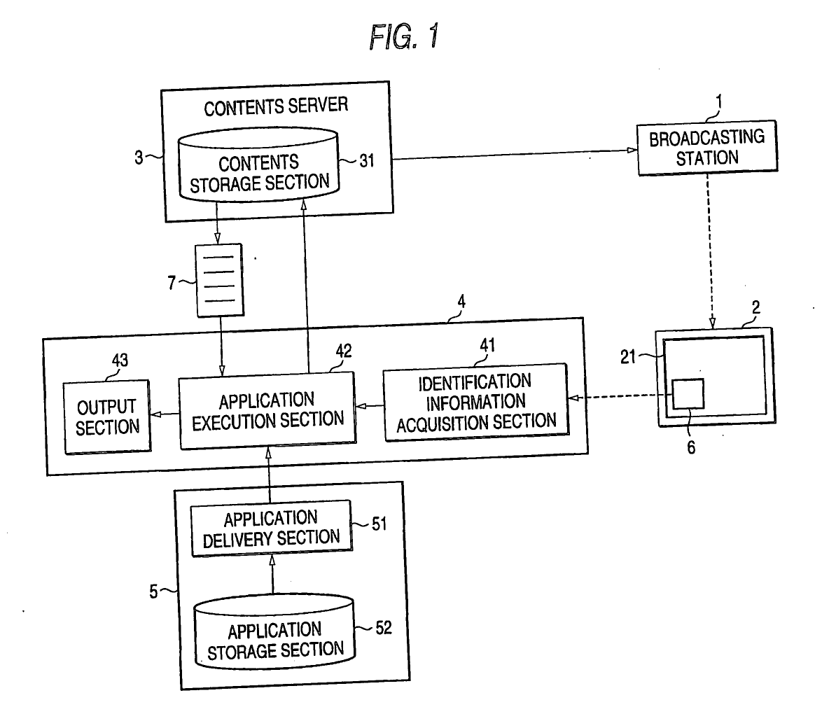

A contents delivery system will be described below referring to the drawings. FIG. 1 is a schematic block diagram showing the configuration of the contents delivery system in accordance with the embodiment of the invention.

In this figure, the contents delivery system comprises a television set 2 serving as an example of an output device for receiving broadcast data delivered from a broadcasting station 1 and for outputting (e.g. displaying) the broadcast data, a contents server 3 serving as an example of a contents delivery device for delivering contents, a mobile phone 4 serving as an example of a terminal device, and an application server 5 for delivering an application that is executed by the mobile phone 4.

The broadcasting station 1 has a broadcasting facility for performing digital broadcasting. This broadcasting facility transmits broadcast data by fixed-line or wireless broadcasting. In addition to television broadcast contents, identification information 6, which is displayed together with the broadcast contents on at least a portion of the output screen 21 of the television set 2, is included in the broadcast data and transmitted.

The television set 2 receives the broadcast data transmitted from the broadcasting station 1 and displays the received broadcast data to the screen 21. In this case, the identification information 6 is output together with programs and commercials in the screen 21.

The identification information 6 is information, for example, that is represented by bar codes, two-dimensional codes (for example, QR codes (registered trademark)), character strings of alphanumeric characters or the like, and output to the screen 21 of the television set 2. This information being different for each program, each commercial or each scene and/or portion of a program, that is, information may be switched to different sequentially with the passage of time.

The contents server 3 includes a contents storage section 31 for storing contents. The contents server 3 reads out, from the contents storage section 31, contents corresponding to the identification information 6 transmitted from the mobile phone 4, and delivers the contents to the mobile phone 4. The contents server 3 has a function of transmitting contents corresponding to the combination of time corresponding to when the identification information is output to the screen 21 and the identification information to the mobile phone 4. More specifically, the contents server 3 has a clock for determining the current time and acquires from the clock function, the time when a contents transmission request is issued from the mobile phone 4. The contents server 3 then reads out the contents corresponding to the combination of the acquired time information and identification information from the contents storage section 31. In this embodiment, the time at which the contents transmission request is issued from the mobile phone 4 is acquired from the clock function of the contents server 3. This acquired time is used as information corresponding to the time output to the screen 21.

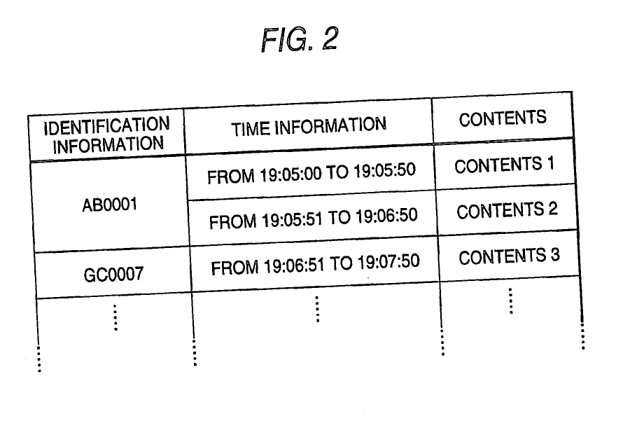

FIG. 2 shows an example of information to be stored in the contents storage section 31. As shown in FIG. 2, identification information, (e.g. identification information 6), time information and contents are stored in the contents storage section 31 in association with one another. The time information indicates a range of the time during which the identification information is acquired. The respective contents include relevant information relating to broadcast contents according to the broadcast data, and the relevant information is at least one or both of information regarding performers or information regarding articles included in the broadcast contents to be delivered according to the broadcast data. For example, the relevant information is information regarding schedules of performers appearing in a program; items, such as clothing, shoes and bags, worn by performers; and prices, distributors, model numbers, materials, etc., of items introduced in the broadcast. The contents regarding the schedules and items are shown as a data list 7 in FIG. 1.

The mobile phone 4 includes an identification information acquisition section 41, an application execution section 42 and an output section 43.

The identification information acquisition section 41 has a function of acquiring the identification information 6 output to the screen 21 of the television set 2. A camera or a bar code reader may be used, for example. The identification information acquired by the identification information acquisition section 41 is output to the application execution section 42 as image data, in the case of the camera, or as bar code information, in the case of the bar code reader.

The application execution section 42 accesses the contents server 4 on the basis of the identification information 6 acquired by the identification information acquisition section 41 and receives the relevant information relating to the contents being broadcast according to the broadcast data. The application execution section 42 for accomplishing this functions as a reception section.

Furthermore, in an embodiment in which the relevant information is included in the identification information 6 acquired by the identification information acquisition section 41, the application execution section 42 has a function of extracting the relevant information on the basis of this identification information. The application execution section 42 for accomplishing this functions as a relevant information extraction section. On the basis of the image data, barcode data, or the like, of the identification information output from the identification information acquisition section 41, the application execution section 42 gains access to the contents server 3 using the identification information, which has been converted into character string codes, for example.

A specific example wherein the identification information 6 is acquired from the above-mentioned identification information acquisition section 41 is described below.

First, a setting is performed to acquire a state wherein the surroundings can be photographed by a CCD (Charge Coupled Device) camera built into the mobile phone 4. Hence, an image of the surroundings is captured by the CCD camera, and the image is displayed on a display screen of the mobile phone 4. The whole of the identification information 6 displayed on the output screen 21 of the television set 2 becomes displayed on the display screen of an output section 43 of the mobile phone 4 by adjusting the position of the mobile phone 4 by the user, for example. In other words, the whole of the identification information 6 can be acquired (photographed) by the CCD camera of the mobile phone 4. When a photographing instruction for a predetermined button of the mobile phone 4 is issued by the user, the identification information acquisition section 41 acquires the identification information 6 captured by the CCD camera. In addition, when bar codes are displayed on the output screen 21 of the television set 2 as the identification information 6, the bar codes are read using the bar code reader built in the mobile phone 4, whereby the identification information acquisition section 41 acquires the identification information 6.

In the above-mentioned example, the whole of the identification information 6 is captured. However, in alternative embodiments, the identification information 6 can be restored in its entirety based on only part of the identification information 6 being captured. It is therefore not always necessary to acquire the whole of the application information 6.

The application execution section 42 downloads an application from the application server 5 (described later) and stores it in a predetermined storage area beforehand. The application execution section 42 then reads out and executes this application, thereby accomplishing the above-mentioned functions.

The output section 43 outputs the contents received by the application execution section 42 and is, for example, a display device, such as a liquid crystal display, or an audio output device (speaker) for outputting sound.

The application server 5 includes an application storage section 52, for storing an application and an application delivery section 51, for reading out the application stored in the application storage section 52 and delivering the application to the mobile phone 4.

The identification information 6 and the contents are created by operators of the broadcasting station 1 and/or operators of the contents server 3 before a program is broadcast or during the broadcast. When the contents are created during the broadcast, the created identification information 6 and contents are renewed during broadcasting, and the renewed identification information 6 is provided to the broadcasting station 1, and then transmitted in a state of being included in the broadcast data. The renewed contents are delivered to the mobile phone 4. Hence, when a real-time program, such as a live broadcast program, is being broadcast, information corresponding to the scenes thereof can be provided.

In an embodiment of the invention, the contents storage section 31 and the application storage section 52 shown in FIG. 1 are formed of a hard disk device, a magnet-optical disk device, a nonvolatile memory device (e.g. a flash memory device), a read out-only recording medium (e.g. a CD-ROM or a volatile memory device such as a RAM (Random Access Memory) device), or a combination of these.

In addition, the application execution section 42 and the application delivery section 51 may be dedicated hardware, or a memory device and a CPU (central processing unit). The functions of the application execution section 42 and the application delivery section 51 may be accomplished, for example, by loading the programs for accomplishing the functions into the memory device and executing the programs.

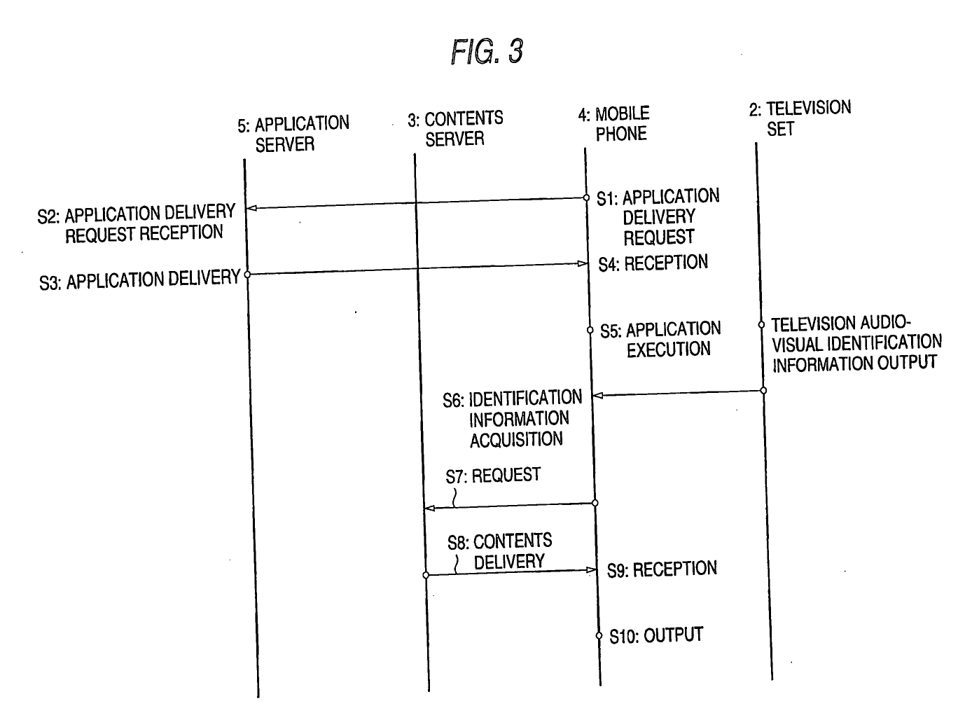

Next, the operation of the contents delivery system in accordance with the above-mentioned embodiment will be described in accordance with FIG. 3, a sequence diagram.

First, the mobile phone 4 transmits an application delivery request to the application server 5 (at step S1).

In response to the application delivery request transmitted from the mobile phone 4 (at step 52), the application delivery section 51 of the application server 5 reads out an application stored in the application storage section 52 and delivers the application to the mobile phone 4 (at step S3).

The application execution section 42 of the mobile phone 4 receives the application transmitted from the application delivery section 51 of the application server 5 (at step 54) and stores the application in a predetermined memory. The application execution section 42 then reads out the application stored in the memory and executes the application (at step 55) on the basis of an execution instruction, e.g., input by the user via an input device such as an operation button device. For example, when a read button is pressed by the user, the identification information 6 displayed on the output screen 21 of the television set 2 is read (photographed) by the identification information acquisition section 41 (at step 56). The application execution section 42 transmits the identification information 6 read by the identification information 6 acquisition section 41 and issues a contents delivery request to the contents server 3 (at step S7).

When the contents server 3 receives the contents transmission request from the mobile phone 4, the contents server 3 acquires the time of the reception from its clock function and reads out, from the contents storage section 31, contents corresponding to the combination of the acquired time information and the identification information 6 received from the mobile phone 4. The contents server 3 then delivers the read out contents to the mobile phone 4 as the data list 7 (at step S8).

The application execution section 42 of the mobile phone 4 outputs the data list 7 received from the contents server 3, (at step 9) to the output section 43 (at step S10).

Referring to the exemplary list of FIG. 2, when the identification information 6 is “AB0001” and the time at which the contents transmission request is issued is “19:05:40”, “contents 1” is read out and transmitted to the mobile phone 4. Then, the contents 1 is displayed on the display screen of the mobile phone 4 as the data list 7. When audio information is included in the contents, sound, such as music or voice, is output from the speaker of the mobile phone 4.

Since the contents corresponding to time can be delivered, to the mobile phone 4, which acquired the same identification information, the contents corresponding to the acquisition time can be delivered, and service corresponding to the time when the identification information is acquired can be provided. In addition, by limiting the range of contents deliverable time information to a broadcast time, contents can be delivered to the user watching a program in real time. Hence, service can be provided while a differentiating between a user who has recorded images of identification information 6 output to the output screen 21 and acquired by reproduction after broadcasting and another user who watched in real time.

The preceding embodiment describes a case in which relevant information is delivered using identification information from the contents server 3. However, in an alternative embodiment, relevant information may be included in identification information 6 itself. In this embodiment, the application execution section 42 can extracts relevant information from the identification information 6 acquired by the identification information acquisition section 41, and outputs the information to the output section 43. Contents coupled with broadcast contents can thus be delivered using a simple configuration.

In another exemplary embodiment, identification information 6 may include relevant information and additionally include reference information (for example, URL (Uniform Resource Locator)) for gaining access to the contents server 3. In this embodiment, when the user watches the relevant information and further requires the relevant information, the user can gain access to the contents server 3 using the reference information (for example, by clicking URL) and can acquire the relevant information stored in the contents server 3 as additional information, thus reducing the number of communications with the contents server 3. More detailed contents relating to broadcast contents accessible that can be accessed using the reference information.

In the above-mentioned embodiment, it is possible to perform authentication, using time information, regarding whether the user is a viewer to whom contents are allowed to be delivered. In other words, when an application is delivered from the application delivery section 51, the identification information 6 of the viewer at a delivery destination and the expiration date information of the application are stored in a predetermined data base beforehand, and when a contents delivery request is issued from the mobile phone 4 using the identification information 6, the time of when the request is issued is checked against the expiration date information. When the time is within the expiration date, the delivery of the contents is permitted; when it is not within the expiration date, the delivery of the contents is rejected. Hence, the contents delivery service can also be provided on a chargeable basis.

In the above-mentioned embodiment, the contents corresponding to the combination of identification information and the time information, indicating the time when the identification information is acquired, are delivered from the contents delivery device to the mobile phone 4. For example, the contents server 3 is provided with a clock function, and the time at which a contents transmission request from the mobile phone 4 is received is acquired from the clock function. However, the mobile phone 4 may be provided with a clock function. Therefore, when the mobile phone 4 issues a contents delivery request to the contents server 3, the mobile phone 4 acquires the information of the time measured by this clock function, transmits the acquired time information to the contents server 3 and issues the contents delivery request. In this case, the information of the current time measured by the clock function of the mobile phone 4 is used as information corresponding to the time output to the output screen 21. However, generally speaking, when two or more mobile phones 4 are used, not all the current time values indicated by the clock functions of the respective mobile phones 4 coincide with one another; hence, the configuration in which the contents server 3 is provided with a clock function is effective in that the time values of the respective mobile phones 4 can be controlled collectively.

In addition, in the above-mentioned embodiment, the information of the time when identification information is output may be embedded in the identification information 6 beforehand. Further, the contents corresponding to the time information may be transmitted from the contents server 3 to the mobile phone 4. The time information embedded in the identification information 6 is used as time corresponding to the time to be output to the output section 43.

Furthermore, it may be possible that programs for accomplishing the functions of the identification information acquisition section 41 and the application execution section 42 shown in FIG. 1 are recorded on a computer-readable recording medium, and that the programs recorded on this recording medium are read in a computer system and executed, whereby contents output processing is carried out. The “computer system” mentioned herein includes an OS and hardware such as peripheral devices.

Moreover, the “computer system” may also include a website provision environment (or display environment) when an Internet or web-based system is used.

Besides, the computer-readable recording medium is a portable medium, such as a flexible disk, a magnet-optical disk a ROM or a CD-ROM, or a storage device, such as a hard disk device, built in the computer system. Additionally, the computer-readable recording medium may also include means for dynamically holding a program for a short time, such as communications lines, in the case when a program is transmitted via a network, such as the Internet, or communications lines, such as telephone lines. In such a case, the medium also includes means for holding a program for a certain period of time, such as a volatile memory device inside a computer system that operates as a server or a client. Still further, the above-mentioned program may be a program for accomplishing part of the above-mentioned functions, or it may also be a program capable of accomplishing the above-mentioned functions when it is combined with a program having already been recorded in the computer system.

Although the various embodiments of the invention have been detailed referring to the drawings, the specific configuration thereof is not limited, but includes designs and the like not departing from the scope and spirit of the invention.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

1. A terminal device comprising:
an identification information acquirer for acquiring identification information output to a display screen of an output device for receiving and displaying broadcast data from a broadcasting station, the identification information being transmitted in the broadcast data and changing over time;
a relevant information extracter for extracting relevant information from the identification information, the relevant information relating to contents to be broadcast according to the broadcast data; and
an output for outputting the relevant information.

2. The terminal device according to claim 1, wherein
the identification information further comprises reference information for gaining access to a contents delivery device for delivering contents comprising more detailed contents relating to broadcast contents; the terminal device further comprising:
a receiver for receiving the more detailed contents from the contents delivery device based on the reference information; and
the output for outputting the received contents.

3. A terminal device comprising:
an identification information acquirer for acquiring identification information output to a display screen of a device for receiving and displaying broadcast data from a broadcasting station, the identification information being included in the broadcast data and changing over time;
a receiver for receiving contents from a contents delivery device, based on the identification information, the contents including relevant information relating to broadcast contents to be broadcast according to the broadcast data; and
an output for outputting the received contents.

4. The terminal device according to claim 3, wherein the relevant information comprises at least one of information regarding performers and information regarding articles included in the broadcast contents.

5. The terminal device according to claim 3, wherein the received contents comprise a time when the identification information is output to the display screen and the identification information.

6. A contents delivery system comprising a display device for receiving broadcast data delivered from a broadcasting station and for outputting the broadcast data, a contents delivery device for delivering contents, and a terminal;
wherein the terminal comprises:
an identification information acquirer for acquiring identification information output to a display screen of the display device, the identification information being transmitted in the broadcast data and changing over time;
a receiver for accessing the contents delivery device based on the identification information, and for receiving, from the contents delivery device, relevant information relating to contents to be broadcast according to the broadcast data; and
an output for outputting the contents;
wherein the contents delivery device delivers, to the terminal, the contents corresponding to the identification information transmitted from the terminal.

7. The contents delivery system according to claim 6, wherein the identification information and the contents are renewed during broadcasting.

8. An information output method comprising:
acquiring identification information included in receiving broadcast data delivered from a broadcasting station and output to a screen of an output device, the identification information changing over time;
extracting relevant information from the acquired identification information, the relevant information relating to contents to be broadcast according to the broadcast data; and
outputting the extracted relevant information.

9. An information output method comprising:
acquiring identification information output to a display screen of an output device that receives and displays broadcast data from a broadcasting station, the identification information being included in the broadcast data and changing over time;
accessing a contents delivery device based on the acquired identification information and for receiving, from the contents delivery device, contents including relevant information relating to contents to be broadcast according to the broadcast data; and
outputting the received contents.

10. A computer readable medium for storing a computer program that outputs identification information, the computer readable medium comprising:
an acquiring code segment that acquires identification information output to a display screen of an output device that receives and displays broadcast data delivered from a broadcasting station identification information being included in the broadcast data and changing with time;
an extracting code segment that extracts relevant from the acquired identification information, the relevant information relating to contents to be broadcast according to the broadcast data; and
an outputting code segment that outputs the extracted relevant information.

11. A computer readable medium for storing a computer program that outputs identification information, the computer readable medium comprising:
an acquiring code segment that acquires identification information output to a display screen of an output device that receives and displays broadcast data from a broadcasting station, the identification information being included in the broadcast data and changing with time;
an accessing code segment that accesses a contents delivery device based on the acquired identification information and receives, from the contents delivery device, relevant information relating to contents to be broadcast according to the broadcast data; and
an outputting code segment that outputs the relevant information.
